(19) United States
(12) Patent Application Publication
(10) Pub. No.: US 2004/0019493 A1
(43) Pub. Date: Jan. 29, 2004

(54) Support system for large transaction process

(76) Inventors: Lois Townsend, Saratoga, CA (US); Dani H. Weinstein, Granite Bay, CA (US); Lee K. Takamori, Corvallis, OR (US)

Correspondence Address: HEWLETT-PACKARD COMPANY, Intellectual Property Administration, P.O. Box 272400, Fort Collins, CO, 80527-2400, US

(21) Appl. No.: 10/208,073

(22) Filed: Jul. 29, 2002

(51) Int. Cl. G06F 17/60

(52) U.S. Cl. 705/1

(57) ABSTRACT

One embodiment disclosed is a support system for large business transactions. The support system includes a large transaction qualifier for filtering potential transactions to select qualified large transactions from among the potential transactions, and a large transaction evaluator for evaluating the qualified large transactions to determine their feasibility and desirability. Another embodiment disclosed is a method for supporting large business transactions. The method includes filtering potential transactions to select qualified large transactions from among the potential transactions, and evaluating the qualified large transactions to determine their feasibility and desirability.

### BACKGROUND OF THE INVENTION

1. Field of the Invention

The present invention relates to customer relationship management support systems.

2. Description of the Background Art

Customer relationship management (CRM) software may assist a company in managing its numerous customer relationships in an organized way. Typically, a database is built about a company's customers. Marketing and sales people may use the CRM database to target their best customers, manage marketing campaigns with clearer objectives, and generate sales leads. In addition, service personnel may use the database to provide a high level of service to highly valued customers.

While CRM software may be used to effectively build relationships between the company's sales force and its various customers, such software does not generally provide support for large business transactions. These large transactions are highly complex and require much more input and analysis than can be supported by current CRM offerings.

### BRIEF DESCRIPTION OF THE DRAWINGS

Non-limiting and non-exhaustive embodiments of the present invention are described in the following figures.

FIG. 1 is a diagram depicting a large transaction support system in accordance with an embodiment of the invention.

FIG. 2 is a flow chart illustrating a method for processing a large business transaction in accordance with an embodiment of the invention.

FIG. 3 is a diagram depicting a large transaction qualifier tool in accordance with an embodiment of the invention.

FIG. 4 is a diagram depicting a large transaction team builder tool in accordance with an embodiment of the invention.

FIG. 5A is a diagram depicting a large transaction evaluator tool in accordance with an embodiment of the invention.

FIG. 5B is a diagram depicting an evaluation engine in accordance with an embodiment of the invention.

FIG. 6 is a diagram depicting a large transaction proposal creator tool in accordance with an embodiment of the invention.

### SUMMARY

One embodiment of the invention is a support system for large business transactions. The support system includes a large transaction qualifier for filtering potential transactions to select qualified large transactions from among the potential transactions, and a large transaction evaluator for evaluating the qualified large transactions to determine their feasibility and desirability. Another embodiment of the invention is a method for supporting large business transactions. The method includes filtering potential transactions to select qualified large transactions from among the potential transactions, and evaluating the qualified large transactions to determine their feasibility and desirability.

### DETAILED DESCRIPTION

Large business transactions, in technology and in other industries, are highly complex. They require input and approval from numerous personnel from various departments within an enterprise. For example, personnel from the marketing and business development departments need to give their qualitative and quantitative input as to how marketing and business development of the product lines of the company would be affected by the transaction, both in the short term and in the longer term. Personnel from the finance department need to give their qualitative and quantitative input as to how the company finances would be affected by the transaction. Personnel in the legal department need to identify and give counsel on any legal ramifications (for example, antitrust) of the transaction. In addition, personnel in operations and administration need to determine and report on the impact of the large transaction on operations and administration.

For a multi-billion dollar company such as Hewlett Packard, large business transactions may typically involve transactions valued at one hundred million dollars or more. However, a large transaction in accordance with the invention may involve a wide range of transaction valuations that depend on the particular company and its industry. The large transactions may instead be better characterized by the complexity of the transaction in terms of the amount of input and analysis required.

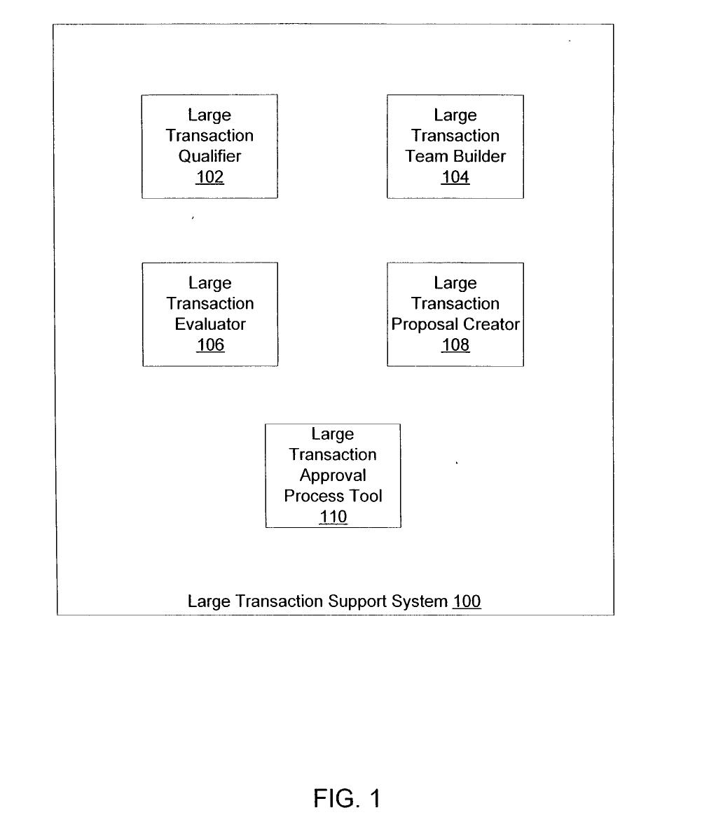

FIG. 1 is a diagram depicting a large transaction support system 100 in accordance with an embodiment of the invention. As depicted in FIG. 1, the large transaction support system 100 may include four components (101, 102, 104, 106, 108, and 110).

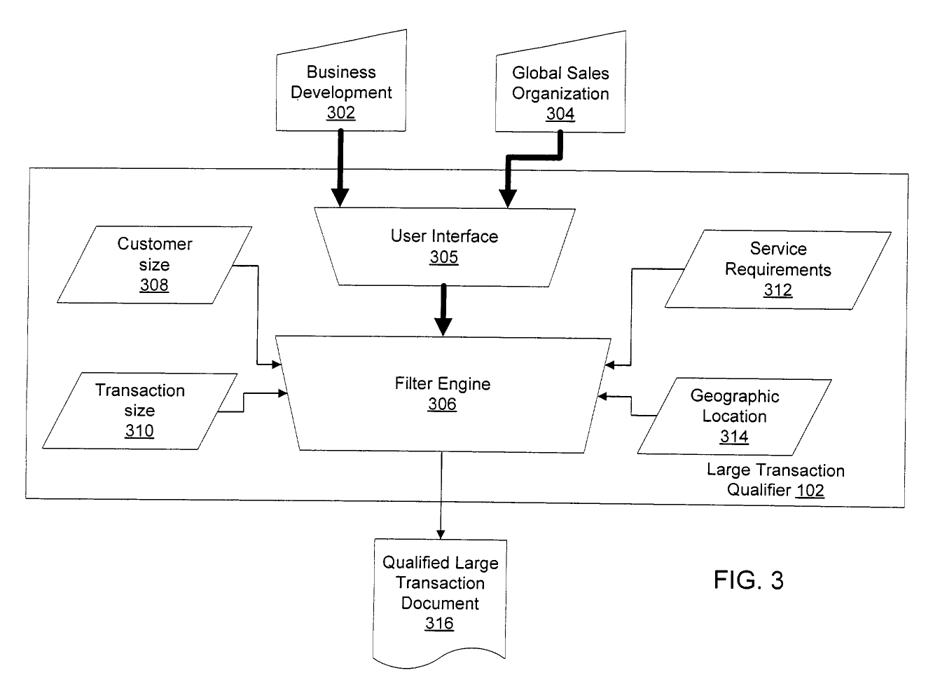

The first component 102 depicted is a large transaction qualifier tool 102. The transaction qualifier 102 filters potential transactions to select qualified large transactions from among the potential transactions. The transaction qualifier 102 is described further below in relation to FIG. 3.

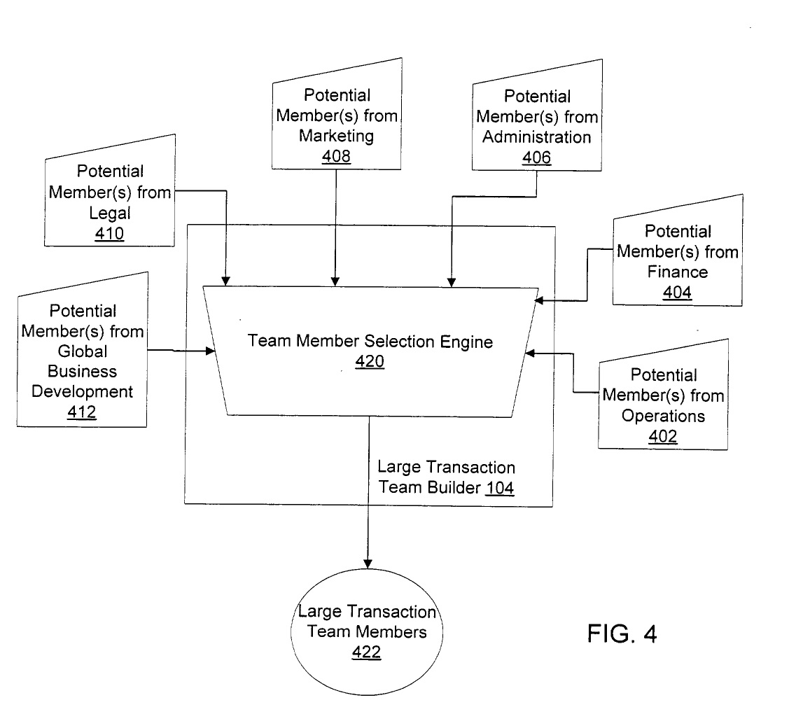

The second component 104 depicted is a large transaction team builder tool 104. The team builder 104 evaluates the qualified large transactions to determine their feasibility and desirability. The team builder 104 is described further below in relation to FIG. 4.

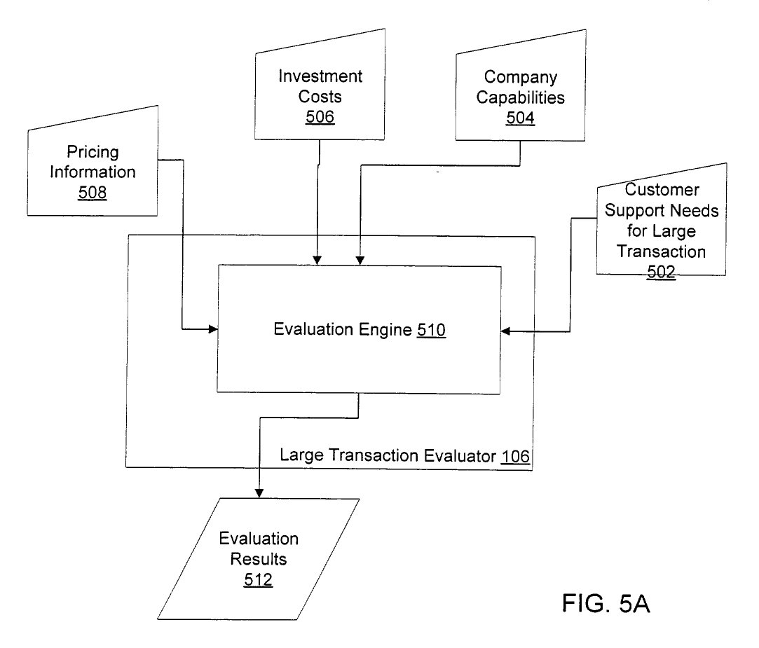

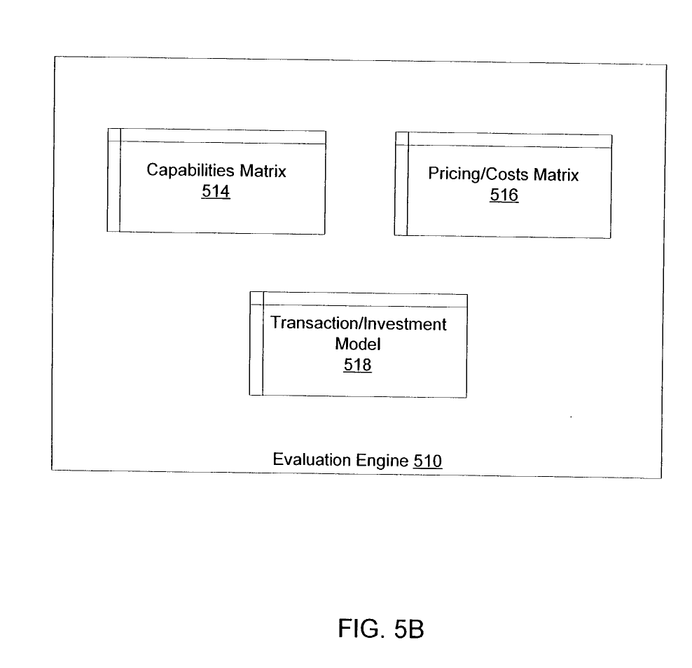

The third component 106 depicted is a large transaction evaluator tool 106. The transaction evaluator 106 evaluates the qualified large transactions to determine their feasibility and desirability. The transaction evaluator 106 is described further below in relation to FIGS. 5A and 5B.

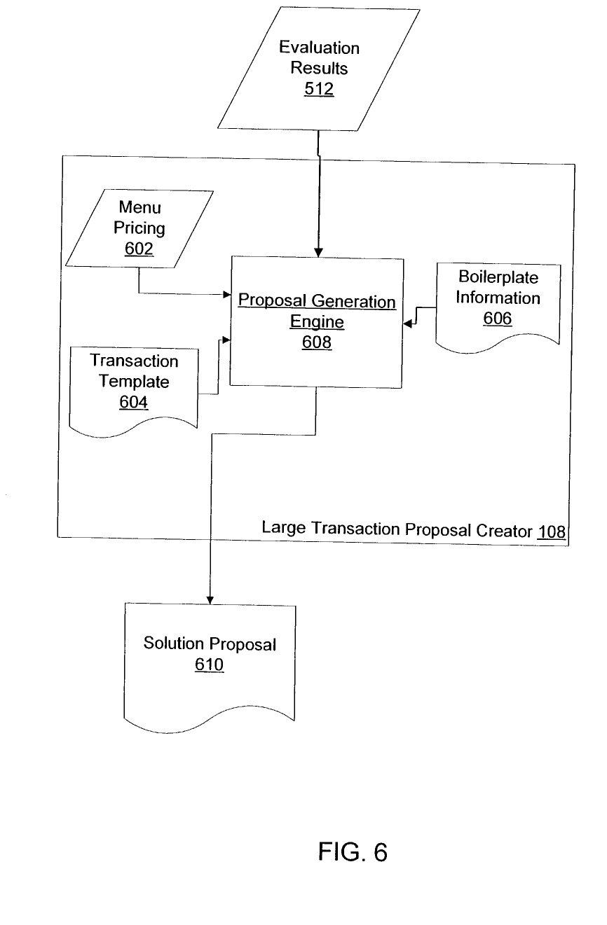

The fourth component 108 depicted is a large transaction proposal creator tool 108. The proposal creator 108 generates a solution proposal incorporating evaluation results from the large transaction evaluator 106. The proposal creator 108 is described further below in relation to FIG. 6.

The fifth component 110 depicted is a large transaction approval process tool 110. The approval process tool 110 is used to determine whether or not the transaction proposal is approved for submission to a solution team. Table 1 below illustrates an example of an approval process tool.

In one embodiment of the invention, the support system 100 and its components may be electronically implemented. For example, the system 100 may be implemented as application software that includes user interfaces to receive user input and database technology to store the user input and other data. In other embodiments, one or more of the components, but not necessarily all of them, may be electronically implemented.

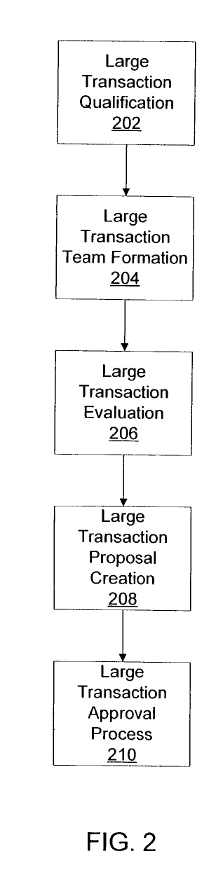

FIG. 2 is a flow chart illustrating a method 200 for processing a large business transaction in accordance with an embodiment of the invention. As depicted in FIG. 2, the method 200 includes five components (202, 204, 206, 208, and 210).

The first step 202 depicted involves large transaction qualification. In this step 202, potential transactions are filtered to select qualified large transactions from among the potential transactions. This step 202 may be implemented, for example, by way of the transaction qualifier 102 described below in relation to FIG. 3.

The second step 204 depicted involves creation of a team for processing the large transaction. This step 204 forms a transaction team to provide input required by the support system. Implementation of this step 204 may be accomplished, for example, by way of the team builder 104 described below in relation to FIG. 4.

The third step 206 depicted involves evaluation of the large transaction. This step 206 evaluates the qualified large transactions to determine their feasibility and desirability. Implementation of this step 206 may be accomplished, for example, by way of the transaction evaluator 106 described below in relation to FIGS. 5A and 5B.

The fourth step 208 depicted involves creation of a proposal for the large transaction. This step 208 generates a solution proposal incorporating evaluation results from the third step 206. Implementation of this step 208 may be accomplished, for example, by way of the proposal creator 108 described below in relation to FIG. 6.

The fifth step 210 depicted involves a large transaction approval process 210. The approval process 210 determines whether or not the transaction proposal is approved for submission to a solution team.

In one embodiment of the invention, the method 200 may be electronically implemented. For example, the method 200 may be implemented using application software that includes user interfaces to receive user input and database technology to store the user input and other data. In other embodiments, one or more of the steps, but not necessarily all of them, may be electronically implemented.

FIG. 3 is a diagram depicting a large transaction qualifier tool 102 in accordance with an embodiment of the invention. As depicted in FIG. 3, the transaction qualifier 102 comprises a filter engine 306. The filter engine 306 receives potential large business transactions from one or more sources. Receipt of these potential transactions may be facilitated, for example, by way of a user interface (UI) 305 to a software application that implements the transaction qualifier 102. In one embodiment, the sources may include a business development group 302 and a global sales organization 304 of the company.

The filter engine 306 filters the potential transactions to select “qualified” large transactions. The selection may be made using qualification criteria. In one embodiment, the qualification criteria may include the customer size 308, the transaction size 310, service requirements of the transaction 312, and the geographic location of the transaction 314. The output of the filter engine 306 may be a qualified large transaction document 316. The qualified document 316 may, for example, be generated by the filter engine 306 by inserting data about the transaction into a qualified large deal form (template). An example of such a template is shown in Table 2 below.

FIG. 4 is a diagram depicting a large transaction team builder tool 104 in accordance with an embodiment of the invention. As depicted in FIG. 4, the team builder 104 comprises a member selection engine 420. The member selection engine 420 receives potential team members from multiple groups or departments within the company. Data on the potential team members may be re-utilized for a subsequent large transaction team. In one embodiment, potential team members may be received from operations 402, finance 404, administration 406, marketing 408, legal 410, and global business development 412 groups within the company.

The member selection engine 306 selects team members from among the potential members received from the various groups. Various factors and criteria may be used in making the selections.

FIG. 5A is a diagram depicting a large transaction evaluator tool 106 in accordance with an embodiment of the invention. As depicted in FIG. 5A, the transaction evaluator 106 comprises an evaluation engine 510. The evaluation engine 510 receives data and criteria regarding various aspects of the transaction. In one embodiment, data and criteria may be received with regard to customer support needs 502 for the qualified transaction, company capabilities 504 as they relate to the transaction, investment costs 506 relating to the transaction, and pricing information 508 relating to the transaction. The evaluation engine 510 analyzes the various data and criteria and outputs the evaluation results 512. One embodiment for a methodology for the analysis is described below in relation to FIG. 5B.

FIG. 5B is a diagram depicting an evaluation engine in accordance with an embodiment of the invention. As depicted in FIG. 5B, the evaluation engine 510 may comprise components including a capabilities matrix 514, a pricing/costs matrix 516, and a transaction/investment model 518. These components may be used by the evaluation engine 510 to analyze the transaction-related data. The matrices and models may, for example, be implemented via electronic spreadsheets.

FIG. 6 is a diagram depicting a large transaction proposal creator tool 108 in accordance with an embodiment of the invention. The proposal creator 108 receives evaluation results 512 from the transaction evaluator 106. A proposal generation engine 608 uses the evaluation results 512 and other information to generate a solution proposal 610. The other information may include, for example, menu pricing 602. In one embodiment, a transaction template 604 may be used in generating the solution proposal 610. In addition, boilerplate information 606 (standard information to be included in such proposals) may be included automatically by the proposal creator 108 in generating the solution proposal 610.

In the above description, numerous specific details are given to provide a thorough understanding of embodiments of the invention. However, the above description of illustrated embodiments of the invention is not intended to be exhaustive or to limit the invention to the precise forms disclosed. One skilled in the relevant art will recognize that the invention can be practiced without one or more of the specific details, or with other methods, components, etc. In other instances, well-known structures or operations are not shown or described in detail to avoid obscuring aspects of the invention. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined by the following claims, which are to be construed in accordance with established doctrines of claim interpretation.

TABLE 1
Approval Process

Step 1: Identify Appropriate Level of Authorization--Initiator
uses Authorization List (AL) to identify appropriate level of
authorizations needed for the large transaction.
Selecting the “Do it” button will launch the AL website in a
new window.
Step 2: Submit Solution Proposal for Approval--Initiator sends the solution
proposal for signature authorization via e-mail to the first authorizer.
The e-mail message should contain all pertinent information including a
completed Solution Proposal, attached to the e-mail.
Step 3: Review of Solution Proposal-First authorizer should carefully re-
view the Solution Proposal to ensure compliance with approval standards.
Step 4: Manager to Approve & Forward to Initiator or Subsequent
Approvers-If approved, the authorizer must state clearly, in the
e-mail, the approval AND forward the approval to initiator or the
next level of approval if it is necessary.
Sample text forwarding back to initiator: “I approve this
solution proposal and return to you.”
Sample text forwarding on to next approver: “I approve this
solution proposal and forward to the next approver, [enter
name here].”
Step 5: Initiator-Submit Approved Solution Proposal-Once all approvers
have approved, the initiator will forward the e-mail chain of approvals to
the Solutions Team.
Step 6: Verify Authorization Siqnatures-The Solutions Team will review
and verify approved Solution Proposal to ensure that it has obtained all the
required authorizations. If not, the Solution Proposal will be returned to
the initiator with explanation.
Step 7: Solutions Team takes over process

TABLE 2
Company or
Customer:

| | |
|---|---|
| Project Team: | Financial Analyst/Manager: |
| | Sales Contact: |
| | Marketing Representative: |
| | REPRESENTATIVE FROM ANY ORGANIZATION INVOLVED IN |
| | THE DEAL: |
| | Operations Manager, if needed: |
| | Corporate Legal, if needed: |
| | 3^{rd} party involvement, if needed: |
| Response Due: | Initial notification date? |
| | By what date and time does CRM owe to HP Sales or Account team? |
| | Request for information: |
| | Are the main components of deal defined so far? |
| | Final pricing? |
| Summary: | TYPE OF BUSINESS: ENTERPRISE, CONSUMER, |
| | COMMERCIAL, EMPLOYEE PURCHASE PROGRAM, |
| | RETAILER, EDUCATIONAL, ETC. EMPLOYEE PURCHASE |
| | PROGRAM (ECP) WHICH CUSTOMER CALLS ‘WIRED WORK |
| | FORCE PROJECT.’ |
| | Scope of project: HP products, support (extended warranty, exchange, |
| | repair, etc.) and services that are being proposed, volume of products to |
| | be delivered, are channels involved or not, which HP entities are part of |
| | the deal, contract terms, logistics, call center for technical support and or |
| | order management, etc. What is the process for changes? |
| | Countries/Field Ops Involved: What locations will the products, support |
| | and services to be delivered? Who is negotiating. driving country? Do we |
| | have the core competencies/capabilities to deliver the committed customer |
| | experience? Native languages required? |
| Timing: | When is the deal to begin and end? |
| | Customer Expections: Can we meet their support and services |
| | expectations? Is the customer expecting support and or services which are |
| | not standard processes? |
| | Competition: Who are we competing against? Do we know what price |
| | we are competing against? Are we competing on an apples-to-apples |
| | comparison? Are we on the short or long list? |
| | CRM Fit: How does this deal fit into the long-term direction of HP's |
| | business? Is the support and or service being offered in any of our |
| | identified growth markets-Consumer, Home Office & Small Office, |
| | Employee Purchase, or Internet? What is the value of this deal beyond HP |
| | and or CRM? |
| Issues to be | What are the major risks in this deal (i.e., financial, new process to |
| Discussed: | implement to achieve customer expectations, 3^{rd} party involvement, etc.) |
| | IS THE DEAL CONTAINING ANY NON-STANDARD |
| | DELIVERABLES (I.E., WARRANTY HARDWARE AND OR |
| | SOFTWARE EXTENSION, ENHANCED IN-WARRANTY |
| | DELIVERY LEVEL, ETC.)? DOES IT EXIST? DOES NOT |
| | EXIST? NON-STANDARD DELIVERABLES ARE NO CURRENT |
| | 24 × 7 TECHNICAL PHONE SUPPORT FOR PERIPHERALS, NO |
| | THREE YEARS WARRANTY EXTENSION, DEDICATED CLIENT |
| | SERVICE TEAM WITH PERSONALIZED GREETING, |
| | PROVIDING ISP SUPPORT AND CUSTOMIZED ORDERING |
| | WEB-SITE. |
| | What issues need to be resolved during the pricing review? (i.e., |
| | discounting, method of payment, timing of payment, funding model, etc.) |
| | WHAT SPECIFICALLY NEEDS TO BE APPROVED? (I.E., ANY |
| | NON-STANDARD PROCESS OR CONDITIONS). CAN OPS |
| | LEVERAGE EXISTING PROCESSES, IS THIS A CORE |
| | COMPETENCY, ETC. TBD |
| | How are the orders & revenues to be recognized, if appropriate? If not, is |
| | this a cost-recovery funding model? |
| | How do we invoice (i.e., centrally or not, to the final users using credit |
| | cards)? What are the billing terms? |
| | If warranty extension or elimination is required, how is SWAT going to |
| | be updated? |
| | What are the audit trails we need to keep to ensure the traceability of the |
| | flow? |
| Pricing Overview | Proposed price to be presented to customer: Price per unit shipped? |
| & Assumptions: | Per-Incident? Bundled in product price? |
| | Uplift: Is it applicable or is the price negotiated on a WW basis in the |
| | customer preferred currency? |
| | Net Profitability: Based on the standard 20% big deal discount or some |
| | other discount amount with appropriate approval, if required. |
| | Currency Exchange Risks: If delivery is remote from the country where |
| | the deal is being booked, how is the currency exchange rate risk |
| | accounted for in the pricing? |
| | Value-Added Tax (VAT): How will this be billed and what are the VAT |
| | implications? |
| | Funding: Have the different components of the deal been priced? Is there |
| | any support and or services given for free for which funding needs to be |
| | provided and authorized? |
| | Financial Flow: Is it clearly defined? |
| | * Important*: Attach appropriate P&Ls. CRM will not approve without |
| | a profitability analysis. |
| Costs Overview: | A separate spreadsheet showing the buildup of CRM costs should be |
| | provided. The buildup should include infrastructure detail. All cost |
| | information should tie to the P&L. Specify source of cost information. |
| | Costs should be approved by finance prior to conference call. |
| Comparable | What other deals are comparable in terms of support and or services |
| Deals: | offered? How do the costs and price of this deal compare to these other |
| | deals? What is the relevant metric to use for this specific deal/program |
| | (i.e., this should be established at deal inception)? |
| | Per unit shipped |
| | Per-Incident |
| | Bundled in product price |
| Other HP | List entity providing non-CRM support and or services. What is the |
| Services: | associated revenue potential? Has pricing input been requested from these |
| | other business units? State the profit margins on these support and or |
| | services, if known (i.e., this is important, if price adjustments are needed). |
| | At a minimum, prices and discounts obtained should be stated. |
| Non-HP Services: | Discuss relationship (i.e., prime, subcontractor, system integrator, vendor) |
| | with any non-HP participant and any associated risks. Is there a fixed |
| | contract over the term deal? What uplift was applied to 3^{rd} party costs? |
| Risks & | What is the worst thing that could happen to this deal? Can CRM absorb |
| Mitigation: | the cost? |
| Contract Issues: | Any non-standard terms and conditions? |
| | Any non-standard process to implement? |
| | Any auditability issue? |
| | Any contract extensions options, if needed? |
| | What is the change of process like deliverable, customer expectations, |
| | etc.? |
| Other Issues & | Is there any reporting needs? |
| Notes: | How do we measure the deal success or customer experience? |
| Approvals | See “CRM Intent to Quote Authorization Matrix” to determine necessary |
| Required: | approvers. Approvals should be obtained in hierarchical order (i.e., |
| | approvals from the lowest authorization level should be received prior to |
| | proceeding to a higher authorization level. Where support and or services |
| | span multiple Field Ops, the impacted Field Ops Business Manager(s) |
| | should be involved. |
| Attachments | P&Ls See attachments which is in a form of profitability matrix. |
| Required: | Cost Buildup See attachments which support the profitability matrix. |
| | Authorization |
| CRM INTENT TO | WW CRM Marketing |
| QUOTE | (Standard Discount %) |
| AUTHORIZATION | WW CRM Marketing Manager |
| MATRIX: | (Additional 10%) |
| | WW CRM Controller |
| | (Additional > 10%) |

What is claimed is:

1. An electronically-implemented support system for large business transactions, the support system comprising:
a large transaction qualifier for filtering potential transactions to select qualified large transactions from among the potential transactions; and
a large transaction evaluator for evaluating the qualified large transactions to determine their feasibility and desirability.

2. The support system of claim 1, wherein the large transaction qualifier receives the potential transactions and selects the qualified large transactions based on data relating to customer size, transaction size, service requirements, and geographic location.

3. The support system of claim 2, wherein the large transaction evaluator analyzes the qualified large transactions based on data relating to customer support needs, company capabilities, investment costs, and pricing information.

4. The support system of claim 3, the system further comprising:
a large transaction team builder for forming a transaction team to provide input required by the support system.

5. The support system of claim 4, wherein the large transaction team builder comprises a member selection engine that draws team members from a plurality of department groups.

6. The support system of claim 5, wherein the plurality of department groups include operations, finance, administration, marketing, legal, and business development.

7. The support system of claim 1, the system further comprising:
a large transaction proposal creator for generating a solution proposal incorporating evaluation results from the large transaction evaluator.

8. The support system of claim 7, wherein the solution proposal is formed using a transaction template.

9. The support system of claim 8, wherein the solution proposal includes menu pricing and boilerplate information.

10. A method for supporting business transactions, the method comprising:
filtering potential transactions to select qualified large transactions from among the potential transactions; and
evaluating the qualified large transactions to determine their feasibility and desirability.

11. The method of claim 10, wherein filtering potential transactions comprises receiving the potential transactions and selecting the qualified large transactions based on data relating to customer size, transaction size, service requirements, and geographic location.

12. The method of claim 10, wherein evaluating the qualified large transactions comprises analyzing the qualified large transactions based on data relating to customer support needs, company capabilities, investment costs, and pricing information.

13. The method of claim 10, method further comprising:
forming a transaction team to provide input required by the method.

14. The method of claim 13, wherein forming the transaction team comprises drawing team members from a plurality of department groups.

15. The method of claim 14, wherein the plurality of department groups include operations, finance, administration, marketing, legal, and business development.

16. The method of claim 10, the method further comprising:
generating a solution proposal incorporating results from evaluating the qualified large transactions.

17. The method of claim 16, wherein the solution proposal is formed using a transaction template.

18. The method of claim 17, wherein the solution proposal includes menu pricing and boilerplate information.

19. The method of claim 110, wherein the method is electronically implemented.

20. A support system for large business transactions, the support system comprising:
means for filtering potential transactions to select qualified large transactions from among the potential transactions; and
means for evaluating the qualified large transactions to determine their feasibility and desirability.

21. The support system of claim 20, the system further comprising:
means for forming a transaction team to provide input required by the support system.

22. The support system of claim 20, the system further comprising:
means for generating a solution proposal incorporating evaluation results from the large transaction evaluator
